(19) United States
(12) Patent Application Publication
(10) Pub. No.: US 2008/0065775 A1
(43) Pub. Date: Mar. 13, 2008

(54) Location data-URL mechanism

(75) Inventor: James M. Polk, Colleyville, TX (US)

Correspondence Address: Law Office of Mark J. Spolyar, 38 Fountain Street, San Francisco, CA, 94114, US

(73) Assignee: Cisco Technology, Inc., San Jose, CA (US)

(21) Appl. No.: 11/520,331

(22) Filed: Sep. 13, 2006

(51) Int. Cl. G06F 15/16

(52) U.S. Cl. 709/228; 709/203; 709/230; 709/227

(57) ABSTRACT

In one embodiment, a mechanism where a client can transmit a request for a digitally-signed location data uniform resource locator (location data-URL), and receive a response including a digitally-signed location data-URL, wherein the location data-URL includes location information corresponding to a requesting host.

### TECHNICAL FIELD

The present invention generally relates to location information systems in networks.

### BACKGROUND

For some network or communications applications, it is desirable to provide location information to client hosts. The Dynamic Host Control Protocol (DHCP) can be configured to provide location to a client. However, the location functionality supported by the existing Dynamic Host Control Protocol does not provide for the security properties desired by the emergency services community. For example, the location information provided to the client does not come from a verifiable source that can be checked during or after an emergency services (e.g., 911) call.

### DESCRIPTION OF THE DRAWINGS

FIG. 1 illustrates an example wireless local area network (WLAN) system.

FIG. 2 is a block diagram illustrating an example message flow in accordance with one possible embodiment of the invention.

FIG. 3 is a block diagram illustrating another example message flow in accordance with a possible embodiment of the invention.

FIG. 4 is a diagram illustrating an example message format according to one embodiment of the invention.

FIG. 5 illustrates an example a hardware system, which may be used to implement a dynamic host configuration server according to one embodiment of the invention.

FIG. 6 illustrates an example a hardware system, which may be used to implement a client host according to one embodiment of the invention.

### DESCRIPTION OF EXAMPLE EMBODIMENT(S)

An embodiment of the invention allows a client host to request a digitally-signed location data-URL that includes location information of the client host. The location data-URL can be forwarded to other applications or remote systems for various uses. Particular embodiments of the present invention are directed to an extended dynamic host configuration mechanism and protocol allowing a client to request and receive location information. In one embodiment, the location information is embodied in a location data uniform resource locator (data-URL) (such as a data-URL defined in L. Masinter, “The data URL scheme”, RFC 2397, August 1998) that indicates the current location of the client. In one embodiment, this mechanism further supports an option allowing the client to request a digitally signed location data-URL, indicating that the location resource locator comes from a verifiable source.

### A. Example Network System Architecture

A.1. Network Topology

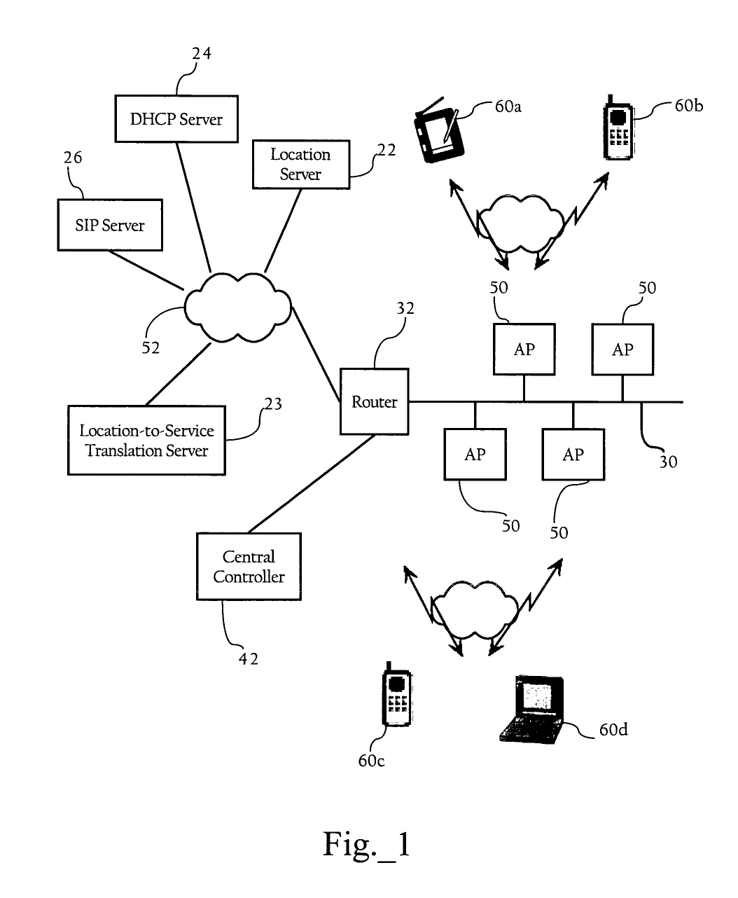

FIG. 1 illustrates example components in a network including one or more components of a wireless local area network (WLAN) system. In a specific embodiment of the present invention, the network environment includes one or more dynamic host configuration servers 24 (plus one or more BootP or DHCP relay agents (not shown), a location-to-service translation server 23, a location server 22, and a session initiation protocol server 26 (e.g., a SIP user agent server). Although these components are illustrated as separate systems, in some embodiments, the functionality of one or more of these components may be integrated into a single physical computing platform.

Location server 22 is operative to provide the location of one or more client hosts in response to a query. For wireless hosts, in one embodiment, location server 22 is operative to collect radio frequency (RF) signal information corresponding to the wireless hosts and use one or more RF models to estimate the location of the wireless hosts. In one embodiment, the location server 22 tracks one or more wireless client hosts to provide the latest known location of the wireless client hosts. In another embodiment, the location server 22 can apply more coarse grain location by returning a location that corresponds to the access point to which a given wireless client host is connected. For wireline client hosts, the location server 22 can be configured to correlate the port to which the client hosts are connected to corresponding locations. To determine a location, the location server 22 can query one or more network elements to determine the port (or receive it from the RFC3046 DHCP relay Agent, which inserted the wireline client's port and switch identification information into the client host's query to the DHCP server), and access a table or other data structure including associations between ports and geographic locations. In accordance with one embodiment of the present invention, when a host is connected to a port of a switch implementing the LAN 30, it uses a link layer discovery mechanism, such as the Cisco Discovery Protocol (CDP), to collect information about the switch. In one embodiment, the host transmits a discovery protocol message to indicate its presence on the network to other devices (e.g., switch), and to learn the port of the switch to which it is connected. In another embodiment, the switch and port identifier of a host can be added by a relay agent to a DHCP message.

Location-to-service translation server 23 is operative to apply a mapping function that returns one or more resource locators each corresponding to a network addressable resource that provides a service to hosts. For example, location-to-service translation server 23 can return a uniform resource locator of a Public Safety Answering Point (PSAP) corresponding to an identified location.

Dynamic host configuration server 24 is operative to provide an Internet Protocol (IP) (or other network address), and optionally other configuration information, to requesting hosts. In one embodiment, dynamic host configuration server 24 implements the Dynamic Host Configuration Protocol (DHCP). Of course, other IP address assignment or configuration protocols, such as BootP, can also be used in connection with the present invention. As discussed below, certain embodiments of the invention extend the dynamic host configuration protocol with certain options that allow a host to obtain a location resource locator.

In the embodiment illustrated in FIG. 1, the network environment may further include a central controller 42, a local area network (LAN) 30, a router 32, and wireless access points 50. LAN 30 is implemented by a switch (or an array of switches) and/or other network devices, such as a bridge.

As FIG. 1 illustrates, the network elements connected to LAN 30 are operably connected to a network 52. Network 52, in one embodiment, generally refers to a computer network, such as a LAN, a WAN, etc., that includes one or more intermediate network devices (e.g., routers, switches, etc.), which allow for the transmission of messages between remote hosts and hosts connected to LAN 30, such as wireless clients connected to LAN 30 via wireless access points 50. Of course, network 52 can include a variety of network segments, transmission technologies and components, such as terrestrial WAN links, satellite links, optical fiber links, and cellular links. Network 52 could also be a campus LAN. LAN 30 may be a LAN, LAN segments implemented by an Ethernet switch (not shown), or an array of switches having multiple ports to which wireless access points 50 are connected. The wireless access points 50 are typically connected to switch ports via Ethernet links; however, other link layer connection protocols or communication means can be employed. FIG. 1 illustrates one possible network environment in which the invention may operate; however, other embodiments are possible. For example, although location server 22, location-to-service translation server 23 and dynamic host configuration server 24 are illustrated as being on a different LAN or LAN segment, it may be co-located with wireless access points 50 and other elements of LAN 30.

The wireless access points 50 are operative to wirelessly communicate with wireless client hosts 60a, 60b, 60c, and 60d. In one embodiment, the wireless access points 50 implement the wireless network protocol specified in the IEEE 802.11 WLAN specification; of course, other wireless network protocols may be used. The wireless access points 50 may be autonomous or so-called “fat” wireless access points, or light-weight wireless access points operating in connection with a wireless switch (not illustrated. In addition, the network infrastructure may also include a Wireless LAN Solution Engine (WLSE) offered by Cisco Systems, Inc. of San Jose, Calif. or another wireless network management system. In some embodiments, the network infrastructure may also include one or more Wireless Control System (WCS) nodes operative to manage one or more wireless switches and access points.

A.2. Example System Architecture for DHCP Server

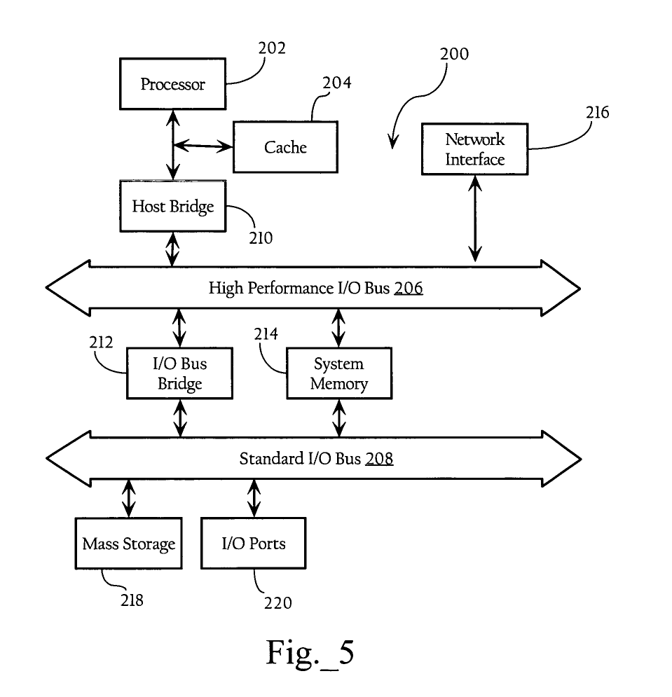

FIG. 5 illustrates an example computing system architecture, which may be used to implement a DHCP server 24, which may be used to perform one or more of the extended dynamic host configuration processes described below. In one embodiment, hardware system 200 comprises a processor 202, a cache memory 204, and one or more software applications and drivers directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218, and I/O ports 220 couple to bus 208. Hardware system 200 may optionally include a keyboard and pointing device, and a display device (not shown) coupled to bus 208. Collectively, these elements are intended to represent a broad category of computer hardware systems, including but not limited to general purpose computer systems based on the Pentium® processor manufactured by Intel Corporation of Santa Clara, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the location server 22, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain embodiments of the present invention may not require nor include all of the above components. For example, the peripheral devices shown coupled to standard I/O bus 208 may couple to high performance I/O bus 206. In addition, in some embodiments only a single bus may exist, with the components of hardware system 200 being coupled to the single bus. Furthermore, hardware system 200 may include additional components, such as additional processors, storage devices, or memories.

As discussed below, in one embodiment, the operations of the DHCP server 24 described herein are implemented as a series of software routines run by hardware system 200. These software routines comprise a plurality or series of instructions to be executed by a processor in a hardware system, such as processor 202. Initially, the series of instructions are stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the Windows®95/98/NT/XP operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like.

A.3. Example System Architecture for Client Host

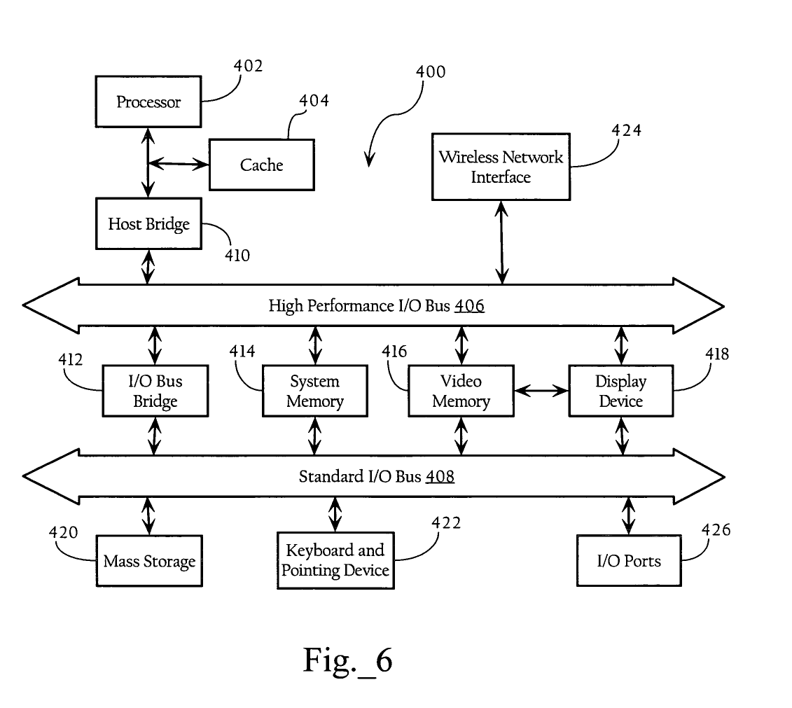

FIG. 6 illustrates an example hardware system 400, which may be used to implement a wireless client host 60. In one embodiment, hardware system 400 includes a processor 402 and a cache memory 404 coupled to each other as shown. Additionally, hardware system 400 includes a high performance input/output (I/O) bus 406 and a standard I/O bus 408. A host bridge 410 couples processor 402 to high performance I/O bus 406, whereas an I/O bus bridge 412 couples the two buses 406 and 408 to each other. Hardware system 400 also includes a wireless network interface 424, a system memory 414, and a video memory 416 couple to bus 406. In turn, a display device 418 couples to video memory 416. A mass storage 420, a keyboard and pointing device 422, and I/O ports 426 couple to bus 408. Collectively, these elements are intended to represent a broad category of computer hardware systems, including but not limited to general purpose computer systems based on the Pentium® processor manufactured by Intel Corporation of Santa Clara, Calif., as well as any other suitable processor.

The remaining elements of hardware system 400 are described below. In particular, wireless network interface 424 provides communication between hardware system 400 and any of a wide range of wireless networks, such as a WLAN (i.e., IEEE 802.11), WiMax (i.e., IEEE 802.16), Cellular (e.g., GSMA), etc. Mass storage 420 provides permanent storage for the data and programming instructions to perform the above described functions implemented in the system controller, whereas system memory 414 (e.g., DRAM) is used to provide temporary storage for the data and programming instructions when executed by processor 402. I/O ports 426 are one or more serial and/or parallel communication ports that provide communication between additional peripheral devices, which may couple to hardware system 400.

Hardware system 400 may include a variety of system architectures; and various components of hardware system 400 may be rearranged. For example, cache 404 may be on-chip with processor 402. Alternatively, cache 404 and processor 402 may be packed together as a “processor module,” with processor 402 being referred to as the “processor core.” Furthermore, certain embodiments of the present invention may not require nor include all of the above components. For example, the peripheral devices shown coupled to standard I/O bus 408 may couple to high performance I/O bus 406. In addition, in some embodiments only a single bus may exist, with the components of hardware system 400 being coupled to the single bus. Furthermore, hardware system 400 may include additional components, such as additional processors, storage devices, or memories.

In one embodiment, the operations of wireless client-side functionality are implemented as a series of software routines run by hardware system 400. In one embodiment, the client host includes a dynamic host configuration client (e.g., a DHCP client) that is operative to interact with a DHCP server (via one or more relay agents) in order to obtain network configuration information. As discussed below, the client functionality can be extended to include an option that allows the client to obtain a location data-URL indicating the location of the client. The client host may also include other functionality, such as SIP user agent modules and one or more communications applications, such as a VoIP client. These software routines, one or more of which can be embodied in a wireless network interface driver, comprise a plurality or series of instructions to be executed by a processor in a hardware system, such as processor 402. Initially, the series of instructions are stored on a storage device, such as mass storage 420. However, the series of instructions can be stored on any suitable storage medium, such as a diskette, CD-ROM, ROM, etc. Furthermore, the series of instructions need not be stored locally, and could be received from a remote storage device, such as a server on a network, via network/communication interface 424. The instructions are copied from the storage device, such as mass storage 420, into memory 414 and then accessed and executed by processor 402. In alternate embodiments, the present invention is implemented in hardware or firmware.

While FIG. 6 illustrates, for didactic purposes, the hardware architecture of a wireless client according to one embodiment of the present invention, the wireless client may, however, be implemented on a wide variety of computer system architectures, such as special purpose, hand held or portable devices, Personal Digital Assistants (e.g., converged devices which support WLAN data+voice), Laptop computers, hand-held phones, and the like. Still further, embodiments of the invention can operate in connection with wireline hosts system, such as a desktop-based IP phone, and a laptop or desktop computer with an Ethernet Network Interface Controller (NIC).

An operating system manages and controls the operation of hardware system 400, including the input and output of data to and from software applications (not shown). The operating system provides an interface, such as a graphical user interface (GUI), between the user and the software applications being executed on the system. According to one embodiment of the present invention, the operating system is the Windows® 95/98/NT/XP operating system and/or Windows® CE (WinCE) operating system, available from Microsoft Corporation of Redmond, Wash. However, the present invention may be used with other operating systems, such as the Apple Macintosh Operating System, available from Apple Computer Inc. of Cupertino, Calif., UNIX operating systems, LINUX operating systems, Symbian operating systems, and the like.

### B. Dynamic Host Configuration and Location Resource Locator

Particular embodiments of the present invention are directed to an extended dynamic host configuration mechanism and protocol allowing a client to request and receive a location data-URL indicating the location of the client. In one embodiment, this mechanism further supports an option allowing the client to request a digitally signed location data-URL, indicating that the location resource locator comes from a verifiable source. For example, the digital signature allows for later verification and validation of the location contents of the location resource locator by some other application or host.

One potential application of the functionality described herein is to address the inability of a SIP Server to add a location-by-value Presence Information Data Format—Location Object (PIDF-LO) [see J. Peterson, “A Presence-based GEOPRIV Location Object Format”, RFC 4119, December 2006] message body to a SIP request from a SIP user agent (UA), which is also the DHCP client in some embodiments. The technology disclosed in J. Polk, B. Rosen, “Session Initiation Protocol Location Conveyance”, draft-ietf-sip-location-conveyance-04.txt, “work in progress”, Sep. 1, 2006 limits the ability of the SIP to include a host location to adding a Location-by-reference URI in the Location header. This can be prone to dereference errors making location of the caller unknown during this, or a future, retrieval transaction.

Other technologies deliver location in a coordinate or civic location (respectively) format via DHCP messages to a client, but do not have the ability to assert the location came from a valid source, or that the integrity of the location information in either option is maintained. For embodiments where it may be desirable to have the source of location determination validated—or queried—this option contains a digital signature of the providing location server. This signature can be, in whole, included in the location data-URL for inclusion by in connection with another protocol when the client transmits its location to a remote node. For example, a SIP user agent (UA) can be a DHCP client receiving its location in the form of location data-URL, with a validated source included (via the digital signature). The SIP UA can then include its location-by-reference as a data-URL (including the digital signature) in a SIP message. This allows the SIP server to view the location information of the client host and verify the source and its integrity with the original location server 22 that provided the client its location. This can be useful for emergency calling scenarios. A SIP server having the location-by-value also prevents a location-by-reference dereference procedure to fail. This dereferencing failure is not desirable within emergency calling scenarios. The digital signature allows, where desired, the SIP server (or other applications) to validate the included location prior to making a routing decision, or a location-to-service translation query, which returns, for example, the specific Public Safety Answering Point (PSAP) URI to forward the SIP request towards.

B.1. Example Message Flow

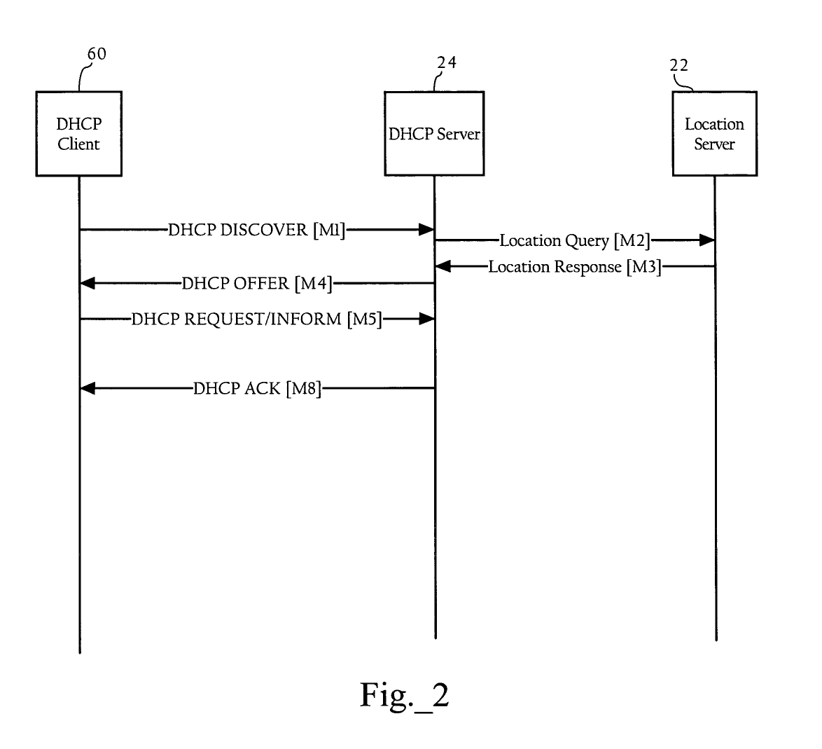

FIG. 2 illustrates an example message flow, according to one embodiment of the invention, where a host (DHCP client 60) can obtain a location data-URL as an integrated part of dynamic host configuration. Various DHCP messages transmitted by a DHCP client can contain a request for a location resource locator (such as DHCP DISCOVER messages [M1] and DHCP REQUEST or INFORM messages [M5]). Likewise, one or more DHCP messages transmitted by a DHCP server 24 can contain a response or answer containing the location resource locator (such as DHCP OFFER messages [M4] and DHCP ACK messages [M8]). The location server 22 and the DHCP server 24 can use any suitable messaging protocols to exchange location information. As discussed below, the location data-URL requests and responses, in one embodiment, are embodied as DHCP Options. In addition, DHCP server 24 can optionally query a location-to-service translation server 23 to obtain an initial PSAP-URI. The DHCP server 24 can include the initial PSAP-URI in a DHCP ACK or other message type to the client host. In one embodiment, the PSAP-URI could be included as a separate DHCP option.

B.2. Message Flow with Validation

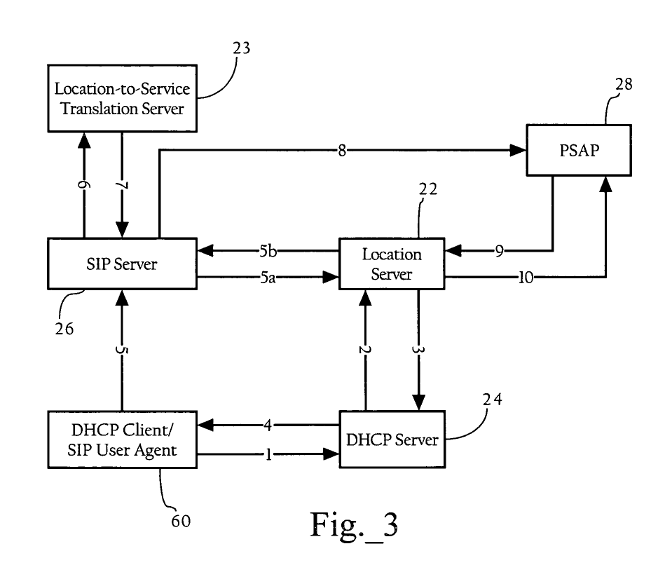

FIG. 3 illustrates another example message flow, according to an embodiment of the invention, where the location data-URL is digitally signed. Other intermediate systems, such as DHCP relay agents are omitted for clarity and ease of description. If the location data-URL in the location data DHCP Option is digitally signed, the location server 22 is the creator of the location information, and the signer of the location data-URL (therefore it can be queried to verify the location data-URL is valid). The digital signature appended to the location data-URL can be verified by one or more applications or remote hosts.

As FIG. 3 illustrates, a client sends a DHCP DISCOVER message to DHCP server including a location data-URL option (Message # 1). The DHCP server 24 queries location server 22 for the location of the client (Message # 2). The location server 22 responds with a digitally signed location data-URL indicating the location of the client (Message # 3). The DHCP server 24 responds to the DHCP DISCOVER message with a DHCP OFFER message including the digitally signed location data-URL (Message # 4). The DHCP server 24 does not change the value of the location data-URL to ensure that it can be verified with reference to the digital signature.

The client may then use this location data-URL in connection with one or more network applications. For example, a SIP user agent of the client, when placing a 911 or emergency call, can create a SIP INVITE message to urn:service:sos, for example, including a SIP Location header with the location data-URL in text format. The SIP server 26 receiving the SIP INVITE can validate the location information in the location data-URL with the location server 22 prior to forwarding the message (Message # 5a). In one embodiment, the location server 22 may provide a new digitally-signed location data-URL with updated location information or an indication that the message is valid (Message # 5b). In another embodiment, the SIP server 26 may simply validate the digital signature of the location data-URL prior to further processing. In one embodiment, the digital signature of the location data-URL may include a time stamp. In such an embodiment, the SIP server 26 may conditionally validate the location information with location server 22 if the time stamp is expired. Otherwise, it uses the location information without verification, assuming the digital signature is valid.

The SIP server may then transmit a query including the location of the client to the location-to-service translation server 23 (Message # 6). The location-to-service translation server 23, in one embodiment, transmits a responsive message identifying a PSAP URI corresponding to the location (Message # 7).

The SIP server 26 forwards the SIP INVITE to the PSAP identified in the PSAP URI (Message # 8). The PSAP 28 may also validate the location data-URL with the location server 22 to verify the location information included in the SIP INVITE message (Message # 9). The location server 22, in one embodiment, validates the location in the location data-URL, providing a responsive message to the PSAP 28 (Message # 10). The location server 22 may be within the client's domain. This may require the configuration of a network path from the PSAP 28 to the location server 22. In another embodiment, the location server 22 may be located in a service provider network, to which a PSAP may have access to the location server 22 for location verification or validation.

B.3. DHCP Relay Option Format

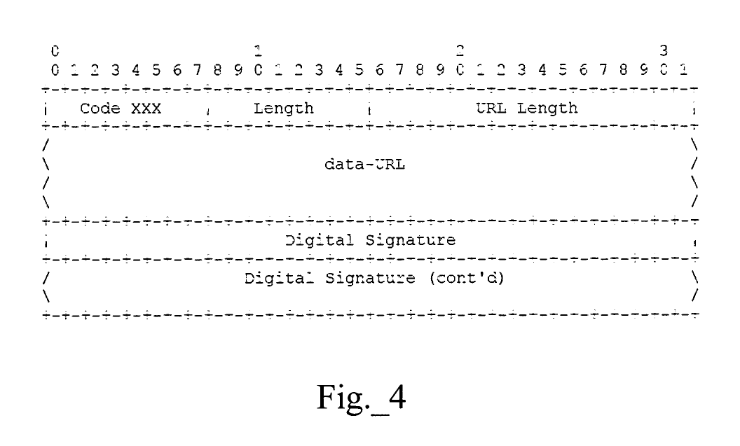

The format, in one embodiment, for the location data-URL Option is illustrated in FIG. 4. Code may be an Internet Assigned Numbers Authority (IANA)-assigned Option number. Length is a two octet value indicating the number of bytes in the Option. URL Length is the octet count of the location data-URL. Data-URL is a variable length field containing the location data-URL being transmitted in the Option. Digital Signature is a variable length field containing the accompanying Digital Signature being transmitted.

In one embodiment, the location data-URL Option is implemented with the following rules of usage. Clients making a request for a location data-URL using this Option send the message to the DHCP server 24 with the URL length field set to zero. Inclusion of a Digital Signature, or a request for one, is optional. A client requesting a digitally-signed location data-URL can set the first two bits of the URL-Length field to binary 11 (i.e., the 17^{th} and 18^{th} bits of the Option). If there is no Digital Signature in a DHCP OFFER or ACK message, the Option length field will be one byte count larger than the URL Length byte count. According to one possible rule implementation, if the Option length field is not one byte count larger than the URL byte count, a Digital Signature of the data-URL should be present and include the remainder of the Option, starting with the byte after the URI Length field byte count. Furthermore, implementation of the option can have the contents of an initial PSAP-URI in a DHCP ACK refreshed periodically, either through unsolicited server-to-client transmissions or client requests. A local policy can determine the mechanism and the refresh rate.

The value of the location data-URL can be any suitable information that conveys location information. For example, the location information may be the global geographical coordinates of the client. In another embodiment, the location information may be CIVIC coordinate values. In one embodiment, the location information may be a small image file depicting a physical region and including a graphical location indicator placed within the physical region. In addition, the location data-URL can be a digitally signed URI to a record on a remote server. The remote server can respond with a challenge for credentials (such as the digital signature of the location data-URL) to condition access to the record.

Location server 22 can employ any suitable technologies or algorithms to create a digital signature. For example, location server 22 can employ asymmetric (public-private key) encryption algorithms, symmetric key encryption algorithms, and hash or message digest algorithms to digitally sign the location data-URL.

The present invention has been explained with reference to specific embodiments. For example, while embodiments of the present invention have been described as operating in connection with IEEE 802.11 networks, SIP and DHCP, the present invention can be used in connection with any suitable wireline and/or wireless network environments, session initiation protocols (e.g., H.323, etc.), and dynamic host configuration protocols (e.g., Boot P, etc.). In addition, embodiments of the invention can be incorporated into, or extend, other protocols, such as the Link Layer Discovery Protocol, Cisco Discovery Protocol, Session Initiation Protocol, and the like. Other embodiments will be evident to those of ordinary skill in the art. It is therefore not intended that the present invention be limited, except as indicated by the appended claims.

What is claimed is:

1. Logic encoded in one or more tangible media for execution and when executed operable to:
transmit a request for a digitally-signed location data uniform resource locator (location data-URL);
receive a response including a digitally-signed location data-URL, wherein the location data-URL includes location information corresponding to a requesting host.

2. The logic of claim 1 wherein the logic is further operable to provide the location data-URL to one or more remote nodes.

3. The logic of claim 1 wherein the logic is further operable to include the location data-URL in a session initiation message transmitted to a remote node.

4. The logic of claim 1 wherein the location data-URL includes geographic location coordinates.

5. A method comprising
transmitting a request for a digitally-signed location data uniform resource locator (location data-URL);
receiving a response including a digitally-signed location data-URL, wherein the location data-URL includes location information corresponding to a requesting host.

6. The method of claim 5 further comprising the location data-URL to one or more remote nodes.

7. The method of claim 5 including the location data-URL in a session initiation message transmitted to a remote node.

8. The method of claim 5 wherein the location data-URL includes geographic location coordinates.

9. Logic encoded in one or more tangible media for execution and when executed operable to:
transmit a dynamic host configuration message including a request for a location data uniform resource locator (location data-URL);
receive a response to the dynamic host configuration message including a location data-URL, wherein the location data-URL includes location information corresponding to a requesting host.

10. The logic of claim 9 wherein the request for a location resource locator is embedded as an option in the dynamic host configuration message.

11. The logic of claim 9 wherein the request for a location resource locator further includes a request for a digitally signed location data-URL.

12. The logic of claim 9 wherein the logic is further operable to transmit a dynamic host configuration discover message including an indication of a request for a location data-URL.

13. The logic of claim 12 wherein the dynamic host configuration discover message is a DHCP DISCOVER message.

14. The logic of claim 9 wherein the logic is further operable to transmit a dynamic host configuration request message including an indication of a request for a location data-URL.

15. The logic of claim 14 wherein the dynamic host configuration request message is a DHCP REQUEST message.

16. The logic of claim 9 wherein the location data-URL is digitally signed.

17. The logic of claim 9 wherein the logic is further operable to provide the location data-URL to one or more remote nodes.

18. The logic of claim 9 wherein the logic is further operable to include the location data-URL in a session initiation message transmitted to a remote node.

19. The logic of claim 9 wherein the location data-URL includes geographic location coordinates.

20. A method comprising
transmit a dynamic host configuration message including a request for a location data uniform resource locator (location data-URL);
receive a response to the dynamic host configuration message including a location data-URL, wherein the location data-URL includes location information corresponding to a requesting host.

21. The method of claim 20 wherein the request for a location resource locator is embedded as an option in the dynamic host configuration message.

22. The method of claim 20 wherein the request for a location resource locator further includes a request for a digitally signed location data-URL.

23. The method of claim 20 further comprising transmitting a dynamic host configuration discover message including an indication of a request for a location data-URL.

24. The method of claim 23 wherein the dynamic host configuration discover message is a DHCP DISCOVER message.

25. The method of claim 20 further comprising transmitting a dynamic host configuration request message including an indication of a request for a location data-URL.

26. The method of claim 25 wherein the dynamic host configuration request message is a DHCP REQUEST message.

27. The method of claim 20 wherein the location data-URL is digitally signed.

28. The method of claim 20 further comprising providing the location data-URL to one or more remote nodes.

29. The method of claim 20 further comprising including the location data-URL in a session initiation message transmitted to a remote node.

30. The method of claim 20 wherein the location data-URL includes geographic location coordinates.

31. Logic encoded in one or more tangible media for execution and when executed operable to:
obtain, responsive to a dynamic host configuration message requesting a location data-URL from a client host, digitally-signed location data-URL from a location server;
provide a digitally-signed location data-URL to the client host, wherein the location data-URL includes location information of the client host.

32. The logic of claim 31 wherein the logic is further operable to query a location-to-service translation server for one or more location-dependent uniform resource locators, each corresponding to a network resource.

33. The logic of claim 32 wherein the network resource is a Public Safety Answering Point (PSAP).
